(19) United States
(12) Patent Application Publication
(10) Pub. No.: US 2009/0312146 A1
(43) Pub. Date: Dec. 17, 2009

(54) METHOD FOR CONTROLLING AN AUTOMATIC TRANSMISSION AND TRANSMISSION CONTROL SYSTEM

(75) Inventor: Andelko VESENJAK, Meckenbeuren (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/480,867

(22) Filed: Jun. 9, 2009

(30) Foreign Application Priority Data
Jun. 16, 2008 (DE) 10 2008 002 440.6

(51) Int. Cl. F16H 59/50

(52) U.S. Cl. 477/107

(57) ABSTRACT

A method of controlling an automatic transmission in a utility vehicle in which a driving strategy is predetermined by a transmission control system. The driving strategy is adjusted as a function of a currently determined load status of the utility vehicle. Furthermore, a transmission control system for an automatic transmission of a utility vehicle, in particular a container vehicle, which comprises a transmission control unit for controlling the transmission in accordance with a predetermined driving strategy. The transmission control unit is coupled to a load recognition module for determining the current load status of the vehicle.

This application claims priority from German patent application serial no. 10 2008 002 440.6 filed Jun. 16, 2008.

### FIELD OF THE INVENTION

The present invention concerns a method for controlling an automatic transmission in a utility vehicle. In addition, the invention concerns a transmission control system for an automatic transmission in a utility vehicle.

### BACKGROUND OF THE INVENTION

Automatic transmissions are understood to be all types of automatically shifted transmissions, for example powershift transmissions or automated manual transmissions.

From automotive technology it is known that vehicles, which change their loading status frequently, often start in a starting gear which is incorrect for the loading status at the time. Either too high a staring gear is chosen in which loading of the clutch is unnecessarily severe, or too low a staring gear is chosen in which starting performance is poor. The same applies to the shift points or the shift engine speeds in such vehicles. For that reason the mass of vehicles with automated transmissions is usually calculated, in order to avoid these drawbacks.

For example, from the document DE 10 2004 015 966 A1 a method is known for determining the starting gear of an automated manual transmission. In the known method, to determine a starting gear the mass of the vehicle and the inclination of the road are taken into account. For example, a higher starting gear can be used if the vehicle's mass is lower than a predetermined value. The mass of the vehicle is either estimated or determined during the vehicle's operation. In the context of estimating the vehicle's mass it is noted whether a period while the vehicle is at rest, is shorter than the time that would be required to carry out a loading process which would change the vehicle's mass to an extent relevant for the starting gear. If this predetermined period is exceeded, it can be assumed with a high degree of probability that the vehicle's mass has changed by virtue of being loaded. However, estimation of the vehicle's mass is a relatively inaccurate process. Since also the vehicle's mass, if calculated, is only determined when the vehicle is in motion, this method of vehicle mass determination also fails to meet the needs. Particularly in the case of container vehicles, which frequently change their containers and therefore the mass they are towing in a very short time, the control of the vehicle's starting process cannot be sufficiently influenced using the vehicle mass determination methods.

### DETAILED DESCRIPTION OF THE PREFERRED EMBODIMENTS

The purpose of the present invention is to propose a method for controlling an automatic transmission in a utility vehicle and a transmission control system, which enable the transmission control to be adapted to the load status of the vehicle.

The objective of the invention can be achieved by a method for controlling an automatic transmission in a utility vehicle, in which, by means of the transmission control system, a driving strategy or suchlike is predetermined and is influenced or modified as a function of the load of the utility vehicle determined at the time.

Automatic transmissions are understood to be all types of automatically shifted transmissions, for example powershift transmissions or automated manual transmissions.

By means of the proposed method, the disadvantages associated with the known methods in relation to calculating vehicle masses can be compensated for in a very simple way, since a change in the load of the vehicle is recognized at once and thus the correct starting gear, i.e. one adapted to the change, can be selected immediately.

For example, the starting gear can be changed as a function of the load condition or the determined loading status in such manner that if the load is high a correspondingly lower starting gear is selected, and if the load is low a correspondingly higher starting gear is selected. In this way the life-span of the starting clutch can be substantially extended, for example if lowerstarting gear-ratios are used when one or more semi-trailers or trailers are attached to the vehicle. In addition, better vehicle acceleration performance can be achieved with higher starting gear-ratios when the vehicle has no load or only a small load, or has no semi-trailer or trailer.

According to a related further development of the invention, the shift engine speed can also be changed as a function of the loading status determined. In this way the vehicle's fuel consumption can be optimized. Furthermore, the number of shift operations can be reduced so that the life-span of actuators, synchronizers or suchlike is extended.

With the method according to the invention it is also possible to change the timing of a shift and/or the gear interval as a function of the determined load status. Thus, different gear intervals can be provided. In addition, the time-point of the shift concerned can be varied.

In a further embodiment variant of the invention it can be provided that the braking strategy is modified as a function of the determined load status. For example, with a higher load the downshift point can also be made higher. Other braking strategies too can be adopted.

The objective of the invention can also be achieved for an automated transmission of a utility vehicle, in particular a container vehicle, by a transmission control system comprising a transmission control unit for controlling the transmission in accordance with a predetermined driving strategy, this transmission control unit being coupled to a load recognition module for determining the load status at any time.

With this in mind, a load recognition module or suchlike can be integrated into the transmission control system so that as soon as the load of the vehicle changes, the driving strategy can be correspondingly adapted.

As the load recognition module for recognizing a number of loaded containers, for example in the case of a container vehicle, a switch and/or a proximity switch and/or a sound sensor and/or a laser switch can be used. In this way, the number of containers in the container vehicle can be determined and this information can be transmitted to the transmission control system or the transmission control unit.

The information on the load status of the vehicle can be transmitted by a vehicle network, such as the CAN, or also via a defined interface. As the said interface, for example an electronic module (E-module) can be used. The module can convey the information by digital or analog means.

A further embodiment variant of the invention can provide that the load recognition is combined with a semi-trailer recognition and/or with a trailer coupling signal recognition. This can further optimize the load recognition module of the vehicle.

1-10. (canceled)

11. A method of controlling an automatic transmission in a utility vehicle in which a driving strategy of the utility vehicle is determined by a transmission control system, the method comprising the step of:
varying the driving strategy as a function of a currently determined load status of the utility vehicle.

12. The method according to claim 11, further comprising the step of changing a starting gear as a function of the determined load status.

13. The method according to claim 11, further comprising the step of changing a shift engine speed as a function of the determined load status.

14. The method according to claim 11, further comprising the step of changing a gear interval as a function of the determined load status.

15. The method according to claim 11, further comprising the step of changing a braking strategy as a function of the determined load status.

16. A transmission control system for an automatic transmission of a utility vehicle, the transmission control system comprising:
a transmission control unit for controlling the automatic transmission in accordance with a predetermined driving strategy, and the transmission control unit being coupled to at least one load recognition module for determining a current load status.

17. The transmission control system according to claim 16, wherein the load recognition module is at least one of a switch, a proximity switch, a sound sensor and a laser switch which recognizes a quantity of loaded containers.

18. The transmission control system according to claim 16, wherein either a vehicle network or a defined interface communicates with the transmission control unit and the load recognition module and facilitates transmission of information therebetween.

19. The transmission control system according to claim 18, wherein the defined interface is one of a digital electronic module and an analog electronic module.

20. The transmission control system according to claim 16, wherein the transmission control unit is coupled to at least one of a semi-trailer and a trailer coupling signal recognition means.
